(19) United States
(12) Patent Application Publication
(10) Pub. No.: US 2026/0251618 A1
(43) Pub. Date: Aug. 27, 2026

(54) Method For Detecting Cracks In A Tubular Pipe

(71) Applicant: Electricite de France, Paris (FR)

(72) Inventors: Jonathan Peixoto, Athis-Mons (FR); Florent Copin, Coye La Foret (FR); Olivier Wattiau, Saint-Denis (FR)

(73) Assignee: Electricite de France, Paris (FR)

(21) Appl. No.: 19/134,949

(22) PCT Filed: Dec. 6, 2023
(86) PCT No.: PCT/FR2023/051944

§ 371 Date: Jun. 2, 2025

(30) Foreign Application Priority Data
Dec. 6, 2022 (FR) FR2212839

(51) Int. Cl. G01N 29/04; G01N 29/06; G01N 29/11; G01N 29/24; G01N 29/265; G01N 29/34

(52) U.S. Cl. CPC G01N 29/043; G01N 29/069; G01N 29/11; G01N 29/2487; G01N 29/265; G01N 29/348; G01N 2291/015; G01N 2291/0234; G01N 2291/2634; G01N 2291/2675

(57) ABSTRACT

The invention relates to a method for detecting and characterising a stress corrosion crack in a tubular pipe (2) at a welded joint (3), the method comprising: a) for measurement positions, positioning the measurement probe (1) and consecutively transmitting and receiving a first, direct-mode, plane-wave burst configured to scan a first region of interest (50) defining an angular range of interest, and at least one second, indirect-mode, burst scanning the angular range of interest; b) constructing a first representation on the basis of the first bursts and a second representation on the basis of the second bursts; c) identifying a trace (220, 240) that appears as a localised variation in amplitude in the first representation and the second representation, with two amplitude peaks (254, 252) in the first representation; d) determining a height of the corrosion crack on the basis of a distance between the two amplitude peaks (254, 252) of the trace (220, 240).

### TECHNICAL FIELD

The present invention relates generally to non-destructive testing, and more specifically to a method for detecting and characterizing defects in a tubular pipe. Such a method is applicable in many industrial sectors including, but in a non-limiting manner: electricity production, petrochemicals, chemistry, the food industry, and more generally, industries operating with fluids circulating in welded steel tubular pipes.

### TECHNOLOGICAL BACKGROUND

Tubular pipes are generally made up of several portions connected together by joints. These joints can, in particular, be welds.

A steel tubular pipe carrying fluid is subject to high stresses, especially when these tubular pipes undergo significant temperature and pressure variations, and also chemical attacks carried by the fluids (gas, water, hydrocarbons, etc.). Defects, called fatigue defects, may appear, resulting in cracks in the pipe material. It should be noted that only the exterior of the pipe is generally accessible, and that inspections must be carried out from this exterior only. Many non-destructive inspection methods have been developed to detect these fatigue defects, and in particular methods using ultrasonic waves.

However, current methods are not suitable for certain materials or for significant thicknesses of the pipe wall under stress. Furthermore, other types of defects may appear, which current non-destructive testing methods cannot reliably detect or characterize. This is particularly the case for stress corrosion cracks. Stress corrosion of a metal or alloy results from the combined action of a tensile mechanical stress (residual or applied stress) and an aggressive surrounding environment on a material sensitive to the phenomenon. It is generally considered that these three conditions (stress, environment and sensitivity of the material to the phenomenon) must be met simultaneously to observe stress corrosion.

Unlike fatigue cracks, stress corrosion cracks, or SCCs, are branched and very slightly open cracks, and above all extend from the inside of the pipe, near a welded joint between two portions of the tubular pipe. Due to the large number of welds on tubular pipes that an industrial installation may include, it is necessary to have a method that not only detects these SCCs, but also characterizes them. Characterization means the location of an SCC and the determination of the height of an SCC, that is to say its radial extension from the inside of the pipe. It is desirable to be able to reliably characterize SCCs even when they are low in height, for example a few millimeters, in order to anticipate degradation of the pipe. Such sensitivity is even more difficult since inspection using ultrasonic waves from the outside requires said ultrasonic waves to pass through the entire thickness of the wall of the tubular pipe.

Crack detection and characterization is even more difficult when the tubular pipe is made of austenitic stainless steel. Austenitic stainless steels have a coarse microstructure (large grain size). These different elements generate significant structure-borne noise and attenuate the propagation of the ultrasonic beam, making the use of ultrasound complex.

### PRESENTATION OF THE INVENTION

Provision is made of a method for detecting and characterizing a stress corrosion crack in a steel tubular pipe at an inspection region extending from a welded joint between two portions of the tubular pipe by means of an ultrasonic probe, comprising:
a) for a plurality of measurement positions distributed circumferentially around the tubular pipe on an external surface of the tubular pipe at the welded joint:
a1) positioning the measurement probe against the external surface at the measurement position, the measurement probe having a transmission surface forming an angle comprised between 10° and 30° relative to a plane tangent to the external surface of the tubular pipe supporting the measurement probe,
a2) successively transmitting and receiving at least two bursts of ultrasound of the same frequency to obtain a plurality of measurement signals, a first, direct-mode, plane-wave burst being configured to scan a first region of interest encompassing the inspection region and the welded joint with a beam axis scanning an angular scanning range at least 10°0 greater than an angular range of interest occupied by the region of interest relative to a plane tangent to the external surface of the tubular pipe supporting the measurement probe, and at least one second, indirect-mode, burst scanning the angular range of interest,
b) constructing a first representation on the basis of the first bursts at a plurality of measurement positions distributed circumferentially around the tubular pipe in which a region characteristic of the welded joint appears, and constructing a second representation on the basis of the second bursts at a plurality of measurement positions distributed circumferentially around the tubular pipe, the first representation and the second representation being two-dimensional data sets associating an amplitude with a location in a two-dimensional space,
c) identifying a trace of a stress corrosion crack that appears as a localized variation in amplitude in the first representation and the second representation, the trace having two amplitude peaks in the first representation constructed from the first, direct-mode, plane-wave bursts,
d) determining a height of the corrosion crack on the basis of a distance between the two amplitude peaks of the trace in the first representation constructed from the first, direct-mode, plane-wave bursts, the height of the crack extending from an internal surface of the tubular pipe.

By means of the proposed method, it is possible to accurately determine the height of a stress corrosion crack from the outside of the tubular pipe, allowing increased accuracy in the evaluation of the condition of the tubular pipe, in particular when the tubular pipe is made of austenitic stainless steel.

This method is advantageously supplemented by the following features, taken alone or in any technically possible combination thereof:
the plurality of bursts comprises at least one indirect-mode, plane-wave burst and at least one indirect-mode, spherical-wave burst, the second construction being obtained from at least one of the indirect-mode, plane-wave burst and the indirect-mode spherical-wave burst;
the plurality of bursts comprises a direct-mode and plane-wave burst whose region of interest extends over the entire thickness of the pipe, including the internal surface of the pipe;
the trace of a stress corrosion crack has a first amplitude peak with a maximum amplitude greater than at least 1.5 times a maximum amplitude of the second amplitude peak;
the trace of a stress corrosion crack has an amplitude trough separating the first amplitude peak and the second amplitude peak, with a minimum amplitude less than 1.5 times the maximum amplitude of the second peak;
the first amplitude peak corresponds to a root of the stress corrosion crack opening onto the internal face of the tubular wall, and the second amplitude peak corresponds to a head of the stress corrosion crack opposite the root of the crack;
the region characteristic of the welded joint is a trace of a penetration echo of the ultrasound that appears as a localized variation in amplitude in the first representation or is a trace of a transition region between a wall of the tubular pipe and a melted region of the welded joint, said trace of the transition region appearing as a line of variation in amplitude;
in step c), the trace of a stress corrosion crack is searched for in a search region likely to contain traces of stress corrosion crack, this search region being located by means of the trace of the penetration echo, or by means of the trace of the transition region;
the measurement probe is carried by a movable assembly on a collar extending over and around the welded joint, and the positioning of the measurement probe at a measurement position among the plurality of measurement positions distributed circumferentially around the tubular pipe comprises the movement of the movable assembly along the collar to said measurement position;
the movable assembly comprises a carriage configured to be moved along the collar and an instrument holder configured to couple the carriage and the measurement probe;
the instrument holder comprises at least one index wheel configured to rotate as the carriage moves along the collar around the tubular pipe, associated with an indexing sensor capable of quantifying the rotation of the index wheel, and the transmission of bursts of ultrasonic waves is conditioned by index information recorded by the indexing sensor.

The invention also relates to a computer program product comprising program code instructions for executing the steps of the method according to the invention, in particular steps b), c) and d), when said program is executed on a computer. The computer program product may be in the form of a non-volatile medium on which the instructions are stored.

### PRESENTATION OF THE FIGURES

Other characteristics, aims and advantages of the invention will emerge from the following description, which is purely illustrative and non-limiting, and which must be read in conjunction with the appended drawings in which:

FIG. 1 is a diagram showing steps of the method according to a possible embodiment of the invention;

FIG. 2 schematically shows a measurement probe near a welded joint between two portions of the tubular pipe, according to a possible embodiment of the invention;

FIG. 3 schematically shows the relative orientations of two sets of transducer elements of the ultrasonic measurement probe, according to a possible embodiment of the invention;

FIG. 4a shows an overall view of a collar of a measurement probe carrier, according to a possible embodiment of the invention;

FIG. 4b shows an example of a clasp of the collar of FIG. 4a, according to a possible embodiment of the invention;

FIG. 5 shows an example of a carriage of a measurement probe carrier, according to a possible embodiment of the invention;

FIG. 6 shows an overview of an example of a carrier, according to a possible embodiment of the invention;

FIG. 7 shows an overview of an instrument holder of a measurement probe carrier, according to a possible embodiment of the invention;

FIG. 8 schematically shows the transmission of a first ultrasound burst, according to a possible embodiment of the invention;

FIG. 9 schematically shows the transmission of a second ultrasound burst or a third ultrasound burst, according to a possible embodiment of the invention;

FIG. 10 schematically shows the transmission of a fourth ultrasound burst, according to a possible embodiment of the invention;

FIG. 11 shows examples of representations resulting from a construction from the measurement signals;

FIG. 12 shows examples of representations resulting from a construction from the measurement signals;

FIG. 13 shows two amplitude peaks of a stress corrosion crack trace that appears as a localized amplitude variation in a representation.

### DETAILED DESCRIPTION

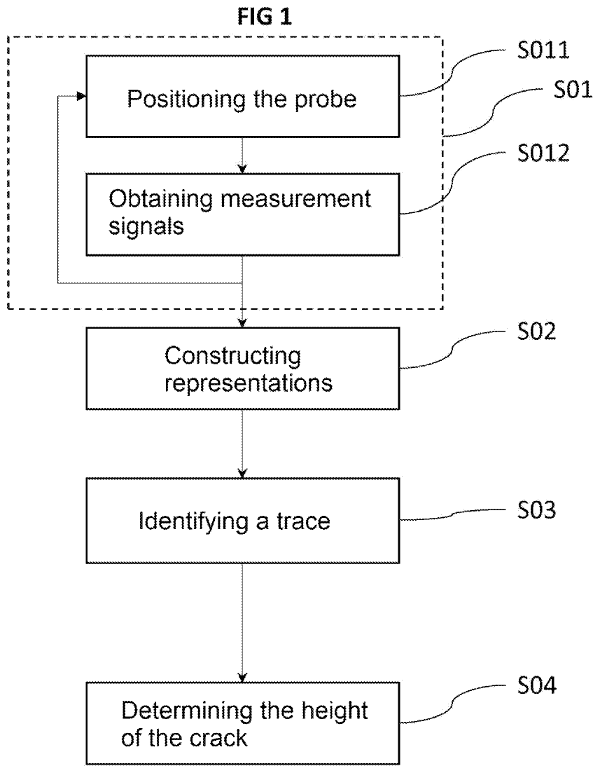

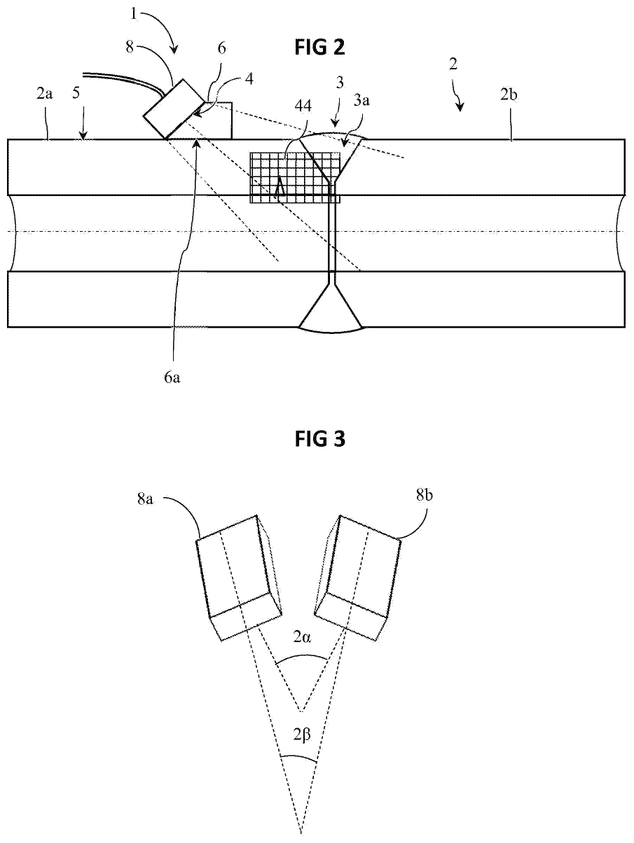

With reference to FIG. 1 and FIG. 2, a method for detecting and characterizing a stress corrosion crack in a steel tubular pipe 2 will be described, at a welded joint 3 between portions 2a, 2b of the tubular pipe 2. A melted region 3a, or weld bead, is present between the respective ends of the portions 2a, 2b of the tubular pipe 2. A first step S01 consists in carrying out measurements for a plurality of measurement positions distributed circumferentially on an external surface of the tubular pipe at a welded joint 3 between two portions 2a, 2b of the tubular pipe by means of an ultrasonic measurement probe 1. For each measurement position, it is first necessary to place the ultrasonic measurement probe 1 (step S011) against the external surface at the measurement position, then to successively transmit and receive at least two ultrasound bursts of the same frequency to obtain a plurality of measurement signals (step S012) at this measurement position.

As illustrated in FIG. 2, the ultrasonic measurement probe 1 is disposed against the external surface 2a of the tubular pipe 2 at a measurement position. The ultrasonic measurement probe 1 has an active transmission surface 4 forming an angle comprised between 10° and 30° relative to a plane tangent to the external surface 2a of the tubular pipe 2 supporting the ultrasonic measurement probe 1. For this purpose, the ultrasonic measurement probe 1 comprises a shoe 6 including an interface surface 6a in contact with the external surface of the tubular pipe, and an inclined plane (typically with an angle comprised between 10° and 30° relative to the interface surface) on which is disposed the active transmission surface 4 of the ultrasonic measurement probe 1, comprising sets of ultrasonic transducers 8. A coupling medium such as water may be disposed between the interface surface 6a of the shoe 6 and the external surface of the tubular pipe. The shoe 6 can be made of any material allowing both the ultrasonic transducers 8 to be held in position and the ultrasonic waves to be transmitted through the shoe 6. For example, the shoe can be made of crosslinked polystyrene.

The ultrasonic measurement probe 1 is configured to highlight the trace of a stress corrosion crack that appears as a localized variation in amplitude in a representation from the measurement signals, the trace having two distinct amplitude peaks. For this purpose, it is possible to vary several parameters of the measurement probe 1, depending on the equipment used. Below are presented some parameters allowing good results to be obtained, although said parameters do not necessarily have to be required for the implementation of the method.

The ultrasonic measurement probe 1 is configured to transmit bursts of ultrasonic waves at a frequency comprised between 2 and 10 MHz, and preferably between 2 and 7.5 MHz. The ultrasonic measurement probe 1 is multi-element and comprises two sets 8a, 8b of transducer elements aligned in the form of bars, as illustrated in FIG. 3. In use, one bar 8a is used for transmission while the other bar 8b is used for reception.

The two bars 8a, 8b may be separated by 2 to 10 mm, and preferably by 0.5 mm to 3.5 mm. The bars are arranged to obtain a refracted angle comprised between −10° and 70°, in an austenitic steel with an approximate speed of the ultrasonic waves of 5700 m/s, after a path in the shoe 6 comprised between 10 mm and 30 mm. The bars 8a, 8b may for example each comprise between 32 and 34 transducer elements. The pitch between the transducer elements may be comprised between 0.6 mm and 1 mm for example.

Preferably, the bars 8a, 8b are not disposed on the same plane, nor parallel. In particular, the bars 8a, 8b may be arranged with a squint angle β, which may be approximated by half the angle formed by the alignments of transducer elements of each bar. The squint angle β may be comprised between 0.1° and 3°. The bars 8a, 8b may have a roof angle α, that is to say a half-angle formed by the axes of the two acoustic beams, comprised between 1.25° and 3.25°.

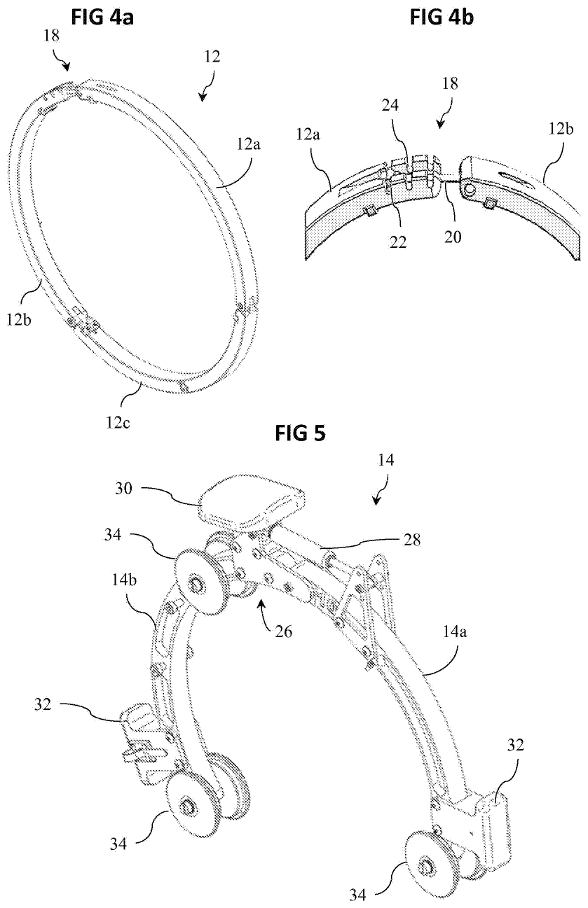

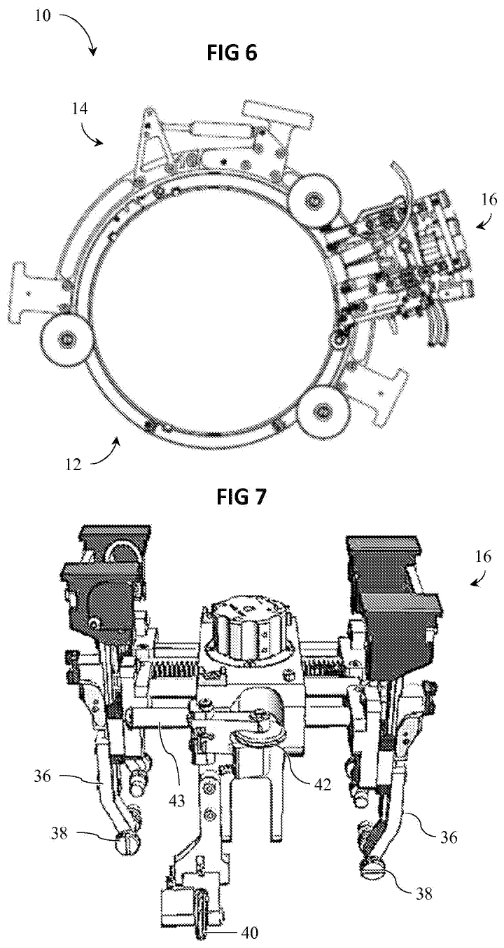

The two phases of the measuring step are repeated several hundred times, the number of measurement positions being preferably greater than 100 around the welded joint 3. In order to allow easy positioning of the ultrasonic measurement probe 1 at each measurement position, it is possible to use a probe carrier 10 as illustrated in FIG. 6 and detailed in FIGS. 4a, 4b, 5, and 7. The purpose of the probe carrier 10 is to carry the measurement probes 1 so that said measurement probes 1 can be movable on and along the probe carrier 10. The probe carrier 10 is placed around the control region near or on the welded joint 3, thus surrounding the tubular elements. Preferably, the carrier 10 comprises several elements: a circular collar 12 surrounding the tubular pipe 2, and an assembly movable along the collar, which may in particular comprise a carriage 14 configured to be moved along the collar 12 and an instrument holder 16 configured to couple the carriage 14 and the measurement probe 1.

FIG. 4a shows an example of a circular collar 12 intended to be mounted on the periphery of the tubular pipe 2 and to surround it. The collar 12 is articulated, comprising several sections 12a, 12b, 12c in the form of circular arcs connected two by two by pivot connections, as well as a clasp 18 comprising several closing positions. FIG. 4b shows an example of a clasp 18. A section 12b of the collar is extended by an arm 20 carrying at its end a crosspiece 22 transverse to the arm 20. Another section 12a of the collar comprises housings 24 configured to receive the crosspiece 22 after radial insertion thereof and to hold it against a circumferential traction. The housings 24 are distributed at several circumferential positions, allowing tightening adapted to the external diameter of the tubular pipe 2 by offering closing positions for several diameters.

FIG. 5 shows an example of a carriage, comprising at least two curved portions 14a, 14b connected by a joint 26, typically establishing a pivoting connection. In this example, a locking member 28 straddling the two curved portions 14a, 14b is actuable by a control member 30 which can also act as a handle for movement. Other dedicated handles 32 may be provided. The locking member 28, preferably a pneumatic cylinder, can move from an unlocked position in which the two curved portions 14a, 14b are movable thanks to the articulation 26 to a locked position in which the articulation 26 is locked, preventing relative movement between the two curved portions 14a, 14b. When the carriage 14 is placed on the collar 12, the articulation 26 is left movable by the locking member 28, and the internal faces of the curved portions 14a, 14b are disposed against the external face of the collar 12. By an action on the control member 30, for example a press if it is a pusher, the articulation 26 is then locked by the locking member 30. The carriage 14 also includes wheels 34 sized to be in contact with the external face of the tubular pipe 2 when the carriage 14 is in place on the collar 12 surrounding this external face of the tubular pipe 2.

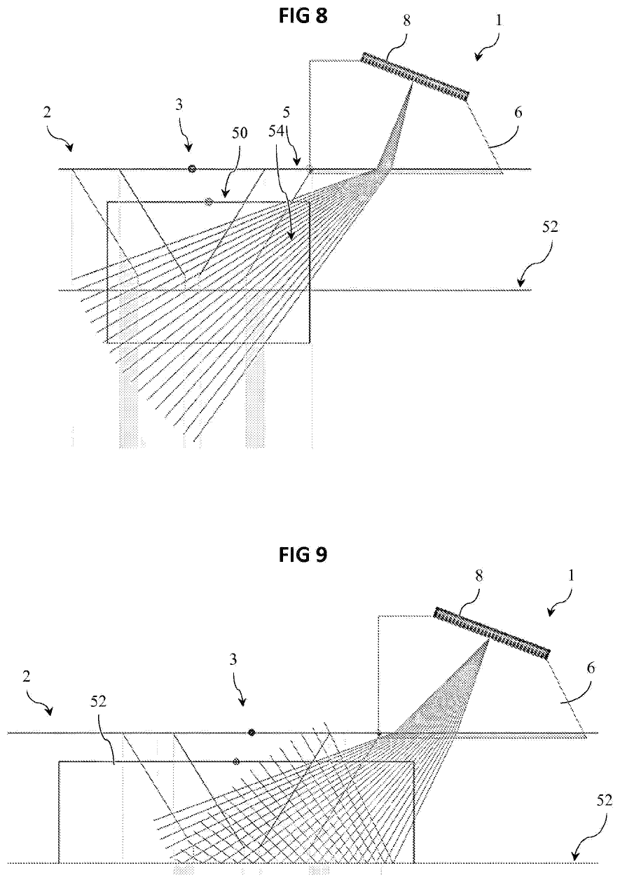

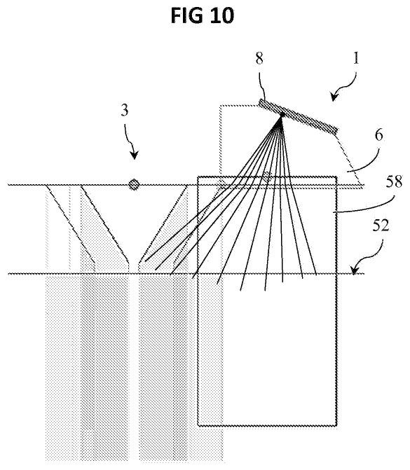

As illustrated in FIG. 6, the carriage 14 and the instrument holder 16 are configured so that the instrument holder 16 is mounted integrally with the carriage 14. The movement of the carriage 14 therefore causes the movement of the instrument holder 16. As visible in FIG. 7, the instrument holder 16 comprises at least one support arm 36 configured to receive an ultrasonic measurement probe 1 on brackets 38 for fixing said support arms 38, offset from the welded joint 3. Preferably, the instrument holder 16 comprises a support arm 36 on each side of its circumferential direction of movement. The instrument holder 16 also comprises at least one index wheel 40, 42, configured to rotate as the carriage 14 moves along the collar 12 around the tubular pipe 2, associated with an indexing sensor capable of quantifying the rotation of the index wheel 40, 42. Preferably, the instrument holder 16 comprises two index wheels 40, 42: a first wheel 40 configured to roll on the tubular pipe 2 and intended for marking on the curvilinear abscissa during the circular movement of the instrument holder 16, and a second wheel 42 configured to roll on a guide 43 between a central portion of the instrument holder 16 and the arm 36 in order to determine an axial offset (along the main axis of the tubular pipe at the welded joint 3) of this arm 36 and therefore of the measurement probe 1 carried by this arm 36 relative to the welded joint 3.

As can be seen in FIG. 2, at a measurement position, the measurement probe 1 is not located radially facing the welded joint 3 or the inspection region extending from the latter in which the SCC are likely to be located. The measurement probe is disposed so as to encompass in an oblique scan a region of interest 44 encompassing the inspection region and the welded joint 3, and is therefore offset relative thereto. By positioning the collar 12 on the welded joint 3, at the weld bead (melted region 3a), and by holding the measurement probe 1 by an arm 36 extending from the movable assembly mounted on the collar 12, correct positioning of the measurement probe 1 is obtained for all the measurement positions, which allows to inspect an inspection region extending all around the welded joint 3 and extending laterally relative to the welded joint 3.

When the collar 12 is mounted on the tubular pipe 2, and the carriage 14 is provided with the instrument holder 10 mounted on the collar 12, the measurement probe 1 can be moved successively between the measurement positions around the circumference of the tubular pipe 2. The rotational movement can be caused manually by pushing on a handle 32, or a motorization can be provided to move the carriage 14 along the collar 12, for example by motorizing the wheels of the carriage 14. During the movement of the carriage 14, the index wheel 40, 42 allows to determine that a new measurement position has been reached, typically after a predetermined distance has been traveled (typically 1 to 3 mm), and the sensor sends index information to the measurement probe 1 or to a control unit to which the measurement probe 1 is connected, in order to cause the transmission of ultrasound bursts at this measurement position. The transmission of bursts of ultrasonic waves is thus conditioned by the index information recorded by the indexing sensor. As a result, it is sufficient to make the movable assembly travel the circumference of the tubular pipe 2 along the collar 14 to travel the plurality of measurement positions distributed circumferentially on an external surface of the tubular pipe 2, and acquire the corresponding measurement signals therein.

At each measurement position, the measurement probe 1 successively transmits and receives at least two ultrasound bursts of the same frequency to obtain a plurality of measurement signals. Preferably, at least three ultrasound bursts are successively transmitted and received, and more preferably at least four ultrasound bursts are successively transmitted and received. In the following example, four ultrasound bursts are successively transmitted and received. The order of the bursts is given for information purposes only, and may be changed.

A first burst transmits in longitudinal plane wave in direct mode (that is to say considering only a direct round trip of the ultrasonic waves between the transducer elements in the region of interest, without taking into account any additional paths related to rebounds and associated with 1 or more changes in the propagation mode of the ultrasound) and is configured to scan a first region of interest 50 with a beam axis scanning an angular scanning range at least 10° greater than an angular range of interest occupied by the first region of interest 50 relative to a plane tangent to the external surface of the tubular pipe 2 supporting the measurement probe 1. The first region of interest 50 is centered on a region 54, located between the welded joint 3 and the measurement probe 1, where the SCCs are likely to be located, and follows on the one hand the outlines of a portion of the tubular pipe at the welded joint 3, and extends a few millimeters therefrom in said portion of the tubular pipe 2, typically over a distance ranging from 5 mm to 20 mm from the melted region 3a. The first region of interest 50 also extends from the interior of the tubular pipe 2, a few millimeters (typically between 5 and 10 mm) from the internal surface 52 of the tubular pipe 2, up to a height of at least 15 mm, and preferably at least 20 mm in the thickness of the wall of the tubular pipe 2. Preferably, the first region of interest 50 passes through the welded joint 3.

For example, the first region of interest 50 may be located at a location comprised between angles 45° and 60° relative to a plane tangent to the external surface 5 of the tubular pipe 2, from the penetration of the ultrasonic waves into the wall of the tubular pipe 2, which is referred to as the angular range of interest. The transducer elements are then controlled to transmit ultrasound by scanning an angular scanning range, for example by means of transmission delays therebetween. Scanning means the displacement of a beam axis corresponding to an axis of higher intensity of the ultrasound or to a median axis of the transmitted ultrasound beam. This angular scanning range extends on either side of the first angular range of interest 50, preferably by at least 5° on each side of the angular range of interest, and more preferably by at least 10°. For example, for an angular range of interest extending between angles 45° and 60°, a scanning angular range might be between 28° and 70° with an angular pitch between 1° and 3°.

A second indirect-mode, plane-wave ultrasound burst is transmitted, sweeping the angular scanning range. The waves can then be transverse, or longitudinal or a combination of the two. The flight time of the waves is longer, which results, as illustrated in FIG. 9, in taking into account waves having undergone multiple reflections, and in particular in taking into account waves having undergone reflection on the internal surface of the tubular pipe. The second region of interest 56 then encompasses and extends the first region of interest in a distal direction opposite the measurement probe 1. A third ultrasound burst is transmitted according to the same modalities as the second ultrasound burst, however with spherical waves rather than plane waves. The second ultrasound burst and the third ultrasound burst serve to distinguish SCCs from other artifacts in the measurement signals 1, and are complementary.

A fourth direct-mode ultrasound burst, illustrated by FIG. 10, is this time centered on a fourth region of interest 58 extending below the measurement probe 1, over the entire thickness of the wall of the tubular pipe 2, and more precisely from the shoe 6 of the measurement probe 1 to more than a thickness of the wall beyond the internal surface 52 of the wall of the tubular pipe. Preferably, this fourth region of interest 58 does not reach the welded joint 3. This fourth burst is used to take into account the echoes of the shoe-pipe interface (in order to determine the coupling), the background echoes on the internal surface 52 of the wall of the tubular pipe 2, and their repetitions, in order to be able to determine the attenuation of the ultrasound.

Once the measurement signals have been obtained for the plurality of measurement positions, a reconstruction of a first representation is carried out on the basis of the first bursts in which a region characteristic of the welded joint 3 appears. A construction of at least one other representation is also carried out from the measurement signals of the second bursts, and/or the third bursts. Preferably, a reconstruction is carried out for each of the other bursts: there is thus a construction of a representation from the second bursts, a construction of a representation from the third bursts and a reconstruction of a representation from the fourth bursts. The reconstructions of the different representations from the different ultrasound bursts, in general, can be carried out with or without mode conversion, that is to say by exploiting the passage from a longitudinal mode to a transverse mode or vice versa, as is practiced and well known in the state of the art. Mode means the mode of propagation of ultrasound: a longitudinal mode which corresponds to the main direction of propagation of the ultrasonic wave, and a transverse mode which is normal to the longitudinal mode.

Preferably, the reconstruction is done by the total focusing method, or TFM, which involves systematically applying the basic focusing principle of phased array ultrasound within a defined region of interest. The region of interest is segmented into a grid of positions, or “pixels,” and phased array beamforming focusing is applied to each pixel within this grid. TFM generates a representation of the region of interest that is focused everywhere and at all depths.

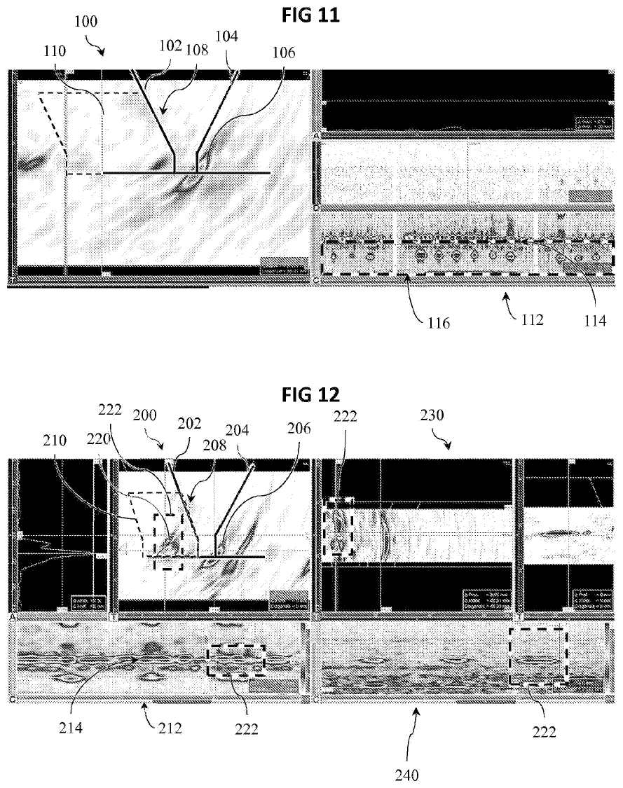

FIGS. 11 and 12 show examples of representations thus obtained. The representations are two-dimensional data sets associating an amplitude with a location in a two-dimensional space. The representations can therefore be in the form of images, as in these figures. FIG. 11 shows for example a first representation 100 obtained on the basis of the first bursts, according to a plane transverse to the welded joint (T-scan), and therefore perpendicular to the circumference of the pipe. The outline of the ends of the two portions 102, 104 coupled by the welded joint is shown therein, which allows to highlight a trace of penetration echo 106 of the ultrasound at the weld bead (melted region 3a) that appears as a localized variation in amplitude in the first representation 100. The trace of the penetration echo is therefore a region characteristic of the welded joint 3. There is also the trace of a transition region 108 between a wall of the tubular pipe 2 and a melted region 3a of the welded joint 3, said trace of the transition region 108 appearing as a line of amplitude variation which follows the geometry of the end of the portion 2a of the tubular pipe 2. The trace of the transition region 108 is also a region characteristic of the welded joint 3. Other regions characteristic of the welded joint 3 can be highlighted, since they appear in a representation even in the absence of defect.

A search region 110 likely to contain traces of stress corrosion crack has been circled in dotted lines. It is in this search region 110 that a possible trace of a stress corrosion crack that appears as a localized variation in amplitude in the first representation is searched. For example, the search region 110 extends in a portion 102 from its end to a distance extending between 5 and 20 mm in the portion 102. The trace of the penetration echo 106 allows to know the position of the welded joint between two portions of the tubular pipe, and therefore to locate, in the first representation, the region 110 likely to contain SCC. FIG. 10 also shows another representation 112 constructed on the basis of the first bursts, but according to a different plane since it is here a C-scan, corresponding to an unrolling of the internal surface of the tubular pipe, where the weld bead 114 appears as an alignment of traces. The search region 116 likely to contain SCC was surrounded by dashes.

In the example of FIG. 11, there is no trace of a stress corrosion crack in the search region 110 of the first representation in the plane transverse to the welded joint. FIG. 12 shows another example, with a first representation 200 based on the first bursts, according to a plane transverse to the welded joint (T-scan). There is the outline of the ends of the two portions 202, 204 coupled by the welded joint 3, and the penetration echo trace 206 allowing to locate the search region 210 likely to contain traces of stress corrosion cracks. There is also the trace of a transition region 208 between a wall of the tubular pipe 2 and a melted region 3a of the welded joint 3, said trace of the transition region 208 appearing as a line of amplitude variation which follows the geometry of the end of the portion 2a of the tubular pipe 2. The search region 116 likely to contain SCC can in particular extend into the portion 2a from this trace of the transition region 208.

In this example, there is a trace 220 of a stress corrosion crack that appears as a localized variation in amplitude in the first representation.

Other representations are illustrated, in which the location of the trace 220 was located by a frame 222. There is the C-scan 212, with the weld bead 214. The first representation 200 and the C-scan 212 are derived from the first bursts, and therefore derived from direct-mode waves. At least one other representation (designated as a second representation) is constructed from bursts other than the first bursts, said other bursts being indirect-mode bursts. These are typically the second bursts and/or the third bursts. This other representation is used to distinguish the trace of the corrosion crack among the artifacts. In this example, there is a second T-Scan representation 230, and a second C-scan representation 240, which can be constructed from the second bursts or the third bursts, or by combining the measurement signals of the second bursts and of the third bursts, and for example by subtracting them.

A trace of a stress corrosion crack appears as a localized variation in amplitude in the first representation and the second representation, the trace having two amplitude peaks in the first representation. If a localized variation in amplitude does not appear in the second representation 230, 240, then a localized variation in amplitude in the first representation is not identified as a trace of a stress corrosion crack. Since the measurement signals result from the indirect-mode bursts, they are less sensitive to possible artifacts, and therefore allow to distinguish the traces of stress corrosion cracks from other artifacts. These artifacts are for example caused by a deflection of the ultrasonic wave beam, a variation in geometry of the portions of the tubular pipe 2, the structure of the material constituting the tubular pipe 2, or the internal surface condition of the tubular pipe 2. It is thus possible to identify the traces of stress corrosion cracks (step S03).

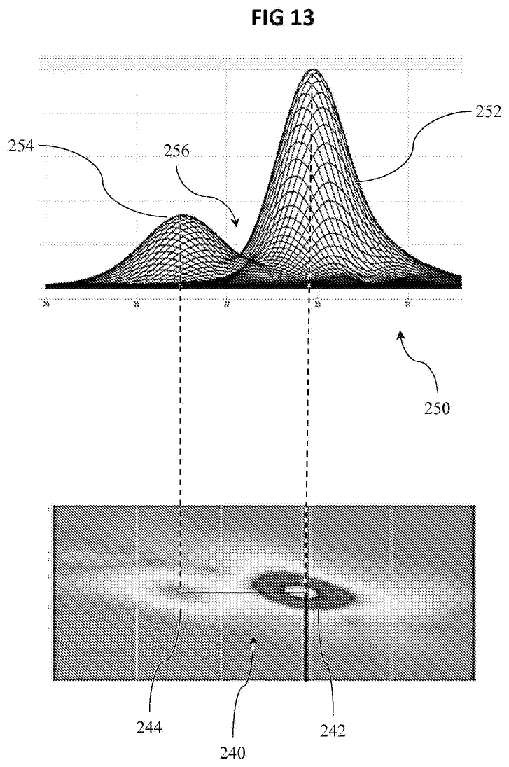

When a trace of a stress corrosion crack has been identified, a height of the corrosion crack can be determined on the basis of a distance between the two amplitude peaks of the trace (step S04). FIG. 13 shows, at the bottom, an example of a trace 240 of a stress corrosion crack identified in a first cross-sectional plane representation. It is seen that the local variation in amplitude of the trace 240 includes two distinct parts: a first part 242, larger in both amplitude and area, and a second part 244, smaller in both amplitude and area. The first part 242 of the trace 240 corresponds to the root of the stress corrosion crack, that is to say the part of the crack which opens onto the internal face of the tubular pipe, while the second part 244 of the trace 240 corresponds to the head of the stress corrosion crack, that is to say the part of the crack which is the deepest in the wall, and therefore the furthest from the internal face 52 of the tubular pipe.

A graph 250 showing the amplitudes corresponding to the trace 240 is represented above this example. A first amplitude peak 252 which corresponds to the root of the crack and a second amplitude peak 254 which corresponds to the head of the crack can be clearly seen. The first amplitude peak 252 has an amplitude greater than the second amplitude peak 254, typically with a maximum amplitude of the first amplitude peak 252 greater than the maximum amplitude of the second amplitude peak 254, and preferably at least 1.5 times greater than the maximum amplitude of the second amplitude peak 254, and more preferably at least twice greater. The amplitudes are not necessarily directly amplitudes of the measurement signals, but can be any indicator related to the energy of the measurement signals.

It should be noted that the various parameters of the measurement probe can be changed in order to reveal preferential characteristics on the trace 240. In particular, it is sought to reveal a maximum of energy on the head of the crack, that is to say that it is sought to obtain a very pronounced first amplitude peak 252. It is also sought to maximize the distance between the two amplitude peaks 252, 254. Finally, it is sought to obtain an amplitude trough 256 between the two amplitude peaks 252, 254, preferably with an amplitude trough 256 whose minimum is less than 1.5 times the maximum amplitude of the second peak 254.

In order to calculate the distance between the two amplitude peaks 252, 254 of the trace 240, it is possible to determine the distance between the respective maximums of these amplitude peaks 252, 254.

The distance between the two amplitude peaks 252, 254 of the trace 240 is directly related to the height of the crack, that is to say the depth of the crack between its root and its head. Knowing the height of the stress corrosion crack allows to characterize the stress corrosion crack, and therefore to evaluate the significance of this stress corrosion crack in terms of the mechanical strength of the tubular pipe. It is then possible to determine whether a maintenance operation, such as reinforcing the tubular pipe with a hoop or replacing a portion of the tubular pipe, must be carried out, and when. It is also possible to monitor the height of the cracks over time by rechecking the tubular pipe 2. It is therefore possible to plan such maintenance operations, then carry them out.

The invention is not limited to the embodiment described and shown in the appended figures. Modifications remain possible, in particular from the point of view of the constitution of the various technical characteristics or by substitution of technical equivalents, without departing from the scope of protection of the invention.

1. A method for detecting and characterizing a stress corrosion crack in a steel tubular pipe at an inspection region extending from a welded joint between two portions of the steel tubular pipe by means of an ultrasonic measurement probe, comprising:
a) for a plurality of measurement positions distributed circumferentially around the steel tubular pipe on an external surface of the steel tubular pipe at the welded joint:
a1) positioning the ultrasonic measurement probe against the external surface at the measurement position, the ultrasonic measurement probe having a transmission surface forming an angle comprised between 10° and 30° relative to a plane tangent to the external surface of the steel tubular pipe supporting the ultrasonic measurement probe,
a2) successively transmitting and receiving at least two bursts of ultrasound of the same frequency to obtain a plurality of measurement signals, the at least two bursts of ultrasound comprising a first, direct-mode, plane-wave burst being configured to scan a first region of interest encompassing the inspection region and the welded joint with a beam axis scanning an angular scanning range at least 10° greater than an angular range of interest occupied by the first region of interest relative to the plane tangent to the external surface of the steel tubular pipe supporting the ultrasonic measurement probe, and at least one second, indirect-mode, burst scanning the angular range of interest,
b) constructing a first representation on the basis of the first-, direct-mode, plane-wave bursts at a plurality of measurement positions distributed circumferentially around the steel tubular pipe in which a region characteristic of the welded joint appears, and constructing a second representation on the basis of the at least one second-, indirect-mode, bursts at a plurality of measurement positions distributed circumferentially around the steel tubular pipe, the first representation and the second representation being two-dimensional data sets associating an amplitude with a location in a two-dimensional space,
c) identifying a trace, of the stress corrosion crack that appears as a localized variation in amplitude in the first representation and the second representation, the trace having two amplitude peaks, in the first representation constructed from the first, direct-mode, plane-wave bursts,
d) determining a height of the stress corrosion crack on the basis of a distance between the two amplitude peaks, of the trace in the first representation constructed from the first, direct-mode, plane-wave bursts, the height of the stress corrosion crack extending from an internal surface of the steel tubular pipe.

2. The method according to claim 1, wherein the plurality of at least one second, indirect-mode, bursts comprises at least one indirect-mode, plane-wave burst and at least one indirect-mode, spherical-wave burst, the second construction being obtained from at least one of the indirect-mode, plane-wave burst and the indirect-mode spherical-wave burst.

3. The method according to claim 1, wherein the plurality of first, direct-mode, plane-wave bursts comprises a direct-mode and plane-wave burst whose first region of interest extends over the entire thickness of the steel tubular pipe, including the internal surface of the steel tubular pipe.

4. The method according to claim 1, wherein the trace of a stress corrosion crack has a first amplitude peak and a a second amplitude peak, wherein the first amplitude peak has a maximum amplitude greater than at least 1.5 times a maximum amplitude of the second amplitude peak.

5. The method according to claim 4, wherein the trace of a stress corrosion crack has an amplitude trough separating the first amplitude peak and the second amplitude peak, with a minimum amplitude less than 1.5 times the maximum amplitude of the second amplitude peak.

6. The method according to claims 4, wherein the first amplitude peak corresponds to a root of the stress corrosion crack opening onto the internal face of the tubular wall, and the second amplitude peak corresponds to a head of the stress corrosion crack opposite the root of the stress corrosion crack.

7. The method according to claim 1, wherein the region characteristic of the welded joint is a trace of a penetration echo of the ultrasound that appears as a localized variation in amplitude in the first representation or is a trace of a transition region between a wall of the steel tubular pipe and a melted region of the welded joint, said trace of the transition region appearing as a line of variation in amplitude.

8. The method according to claim 7, wherein in step c), the trace of the stress corrosion crack is searched for in a search region likely to contain traces of stress corrosion crack, the search region being located by means of the trace of the penetration echo, or by means of the trace of the transition region.

9. The method according to claim 1, wherein the ultrasonic measurement probe is carried by a movable assembly on a collar extending over and around the welded joint, and the positioning of the ultrasonic measurement probe at a measurement position among the plurality of measurement positions distributed circumferentially around the steel tubular pipe comprises the movement of the movable assembly along the collar to said measurement position.

10. The method according to claim 9, wherein the movable assembly comprises a carriage configured to be moved along the collar and an instrument holder configured to couple the carriage and the ultrasonic measurement probe.

11. The method according to claim 10, wherein the instrument holder comprises at least one index wheel configured to rotate as the carriage moves along the collar around the steel tubular pipe, associated with an indexing sensor capable of quantifying the rotation of the at least one index wheel, and the transmission of the at least two bursts of of ultrasound is conditioned by index information recorded by the indexing sensor.

12. A computer program product comprising program code instructions for executing the steps b), c) and d) of the method according to claim 1, when said program is executed on a computer.
